(19) United States
(12) Patent Application Publication
(10) Pub. No.: US 2026/0211385 A1
(43) Pub. Date: Jul. 23, 2026

(54) SMARTFARM MANAGEMENT METHOD AND APPARATUS USING VIRTUAL SENSORS

(71) Applicant: Electronics and Telecommunications Research Institute, Daejeon (KR)

(72) Inventors: Jae Heon KIM, Suncheon-si (KR); Meong Hun LEE, Suncheon-si (KR); Hyun YOE, Suncheon-si (KR); Hyeon O CHOE, Suncheon-si (KR); Seung Jae KIM, Gwangyang-si (KR)

(73) Assignee: Electronics and Telecommunications Research Institute, Daejeon (KR)

(21) Appl. No.: 19/139,520

(22) PCT Filed: Dec. 28, 2022
(86) PCT No.: PCT/KR2022/021516

§ 371 Date: Jun. 16, 2025

(30) Foreign Application Priority Data
Dec. 20, 2022 (KR) 10-2022-0179753

(51) Int. Cl. G05B 13/04; G06Q 50/02

(52) U.S. Cl. CPC G05B 13/04; G06Q 50/02

(57) ABSTRACT

This SmartFarm management method using virtual sensors comprises steps in which a management apparatus: receives information measured by actual sensors, information measured by the virtual sensors, and state information about an environment management device; monitors SmartFarm on the basis of the information measured by the real sensors, the information measured by the virtual sensors, and the state information about the environment management device; analyzes the monitoring result through a deep learning model so as to detect whether there is an anomaly in the real sensors and the virtual sensors; and manages the SmartFarm by controlling the real sensors, the virtual sensors and the environment management device on the basis of the detection result.

### TECHNICAL FIELD

The technology described below is a SmartFarm (or a smart livestock barn) management method. Particularly, the technology described below relates to a SmartFarm management method using a virtual sensor.

The present application is a result of research conducted in 2022 with the support of the Institute for Information & communication Technology Planning & evaluation (project number: 2022-0-00591-001, project identification number: 1711160509, and project name: DEVELOPMENT OF VIRTUAL SENSOR FRAMEWORK TECHNOLOGY FOR RESOLVING SENSOR SHADING REGION IN DIGITAL TWIN ENVIRONMENT).

### BACKGROUND ART

A SmartFarm refers to agriculture system using information processing technology. The SmartFarm measures a temperature, humidity, the amount of sunlight, information about soil, and so on, and then drives a controlling apparatus on a farm on the basis of the measured results.

There are various types of sensors used in a SmartFarm. In addition, a virtual sensor is often installed in a SmartFarm. The virtual sensor refers to a sensor that predicts a property such as a quality of a product by processing values such as a temperature, a flow rate, and so on that a real sensor measures. The virtual sensor has an advantage of being able to replace an existing expensive analyzer or to detect a new value.

Particularly, the use of a model using an artificial neural network for data analysis has become increasingly common recently. Therefore, there are more and more sensors that measure new values by analyzing, through an artificial neural network model, a temperature, a flow rate, and so on that the real sensor measures.

### DISCLOSURE

### Technical Problem

In a livestock barn in a SmartFarm system, real sensors and virtual sensors are often installed. In many situations, when the real sensors fail, the virtual sensors are also affected.

In the technology described below, a method of predicting a failure of real sensors that affect virtual sensors is provided.

### Technical Solution

A SmartFarm management method using a virtual sensor includes: receiving, by a management apparatus, information measured by a real sensor, information measured by the virtual sensor, and status information of an environment management device; monitoring, by the management apparatus, the SmartFarm on the basis of the information measured by the real sensor, the information measured by the virtual sensor, and the status information of the environment management device; detecting, by the management apparatus, whether there is an abnormality in the real sensor and the virtual sensor by analyzing a monitoring result by using a deep learning model; and managing, by the management apparatus, the SmartFarm by controlling the real sensor, the virtual sensor, and the environment management device on the basis of a detection result.

### Advantageous Effects

By using the technology described below, a SmartFarm is capable of being managed.

By using the technology described below, a state inside the SmartFarm is capable of being identified.

By using the technology described below, a state of each sensor inside the SmartFarm is capable of being identified. Through this, unnecessary replacement of each sensor is capable of being reduced. In addition, a financial loss that may occur due to a failure of a sensor is capable of being minimized.

By using the technology described below, a state of the environment management device inside the SmartFarm is capable of being identified.

### DESCRIPTION OF DRAWINGS

FIG. 1 is a view illustrating the overall process in which a SmartFarm management apparatus manages a SmartFarm.

FIGS. 2A and 2B show that the SmartFarm management apparatus detects an abnormality.

FIGS. 3A, 3B, and 3C show that the SmartFarm management apparatus controls each sensor.

FIG. 4 is a view illustrating a configuration of a SmartFarm management apparatus.

### MODE FOR INVENTION

The technology described below may be made with various changes and have various embodiments. The drawings in the specification may describe specific embodiments of the technology described below. However, this is for explanation of the technology described below and is not intended to limit the technology described below to specific embodiments. Therefore, it should be understood that all changes, equivalents, or substitutes included in the spirit and technical scope of the technology described below are included in the technology described below.

Terms such as first, second, A, B, and the like may be used to describe various elements. However, these elements are not limited by these terms and are merely used to distinguish one element from another. For example, without departing from the scope of the technology described below, a first element may be referred to as a second element and in a similar way, the second element may be referred to as a first element. “And/or” includes any combination of a plurality of related recited items or any one of a plurality of related recited items.

Singular forms are intended to include plural forms as well, unless the context clearly indicates otherwise. It will be further understood that the terms “comprises” and/or “comprising”, when used in this specification, specify the presence of features, numbers, steps, actions, components, parts, or combinations thereof, but do not preclude the presence or addition of one or more other features, numbers, steps, actions, components, parts, or combinations thereof.

Prior to the detailed description of the drawings, it is to be clarified that the classification of components in the present specification is merely made depending on the main function of each component. That is, two or more components described below may be combined into one component or one component may be divided into two or more depending on each more detailed function. In addition, each component to be described below may further perform some or all of the functions of other components in addition to its main function, and some of the main functions of each component may be performed exclusively by other components.

In addition, in implementing a method or operation method, respective steps constituting the method may occur in a different order from a specific order unless the specific order is clearly described in context. That is, the steps may be performed in the specific order, substantially simultaneously, or the reverse order as specified.

First, the overall process in which a SmartFarm management apparatus (hereinafter, the management apparatus) manages a SmartFarm will be examined.

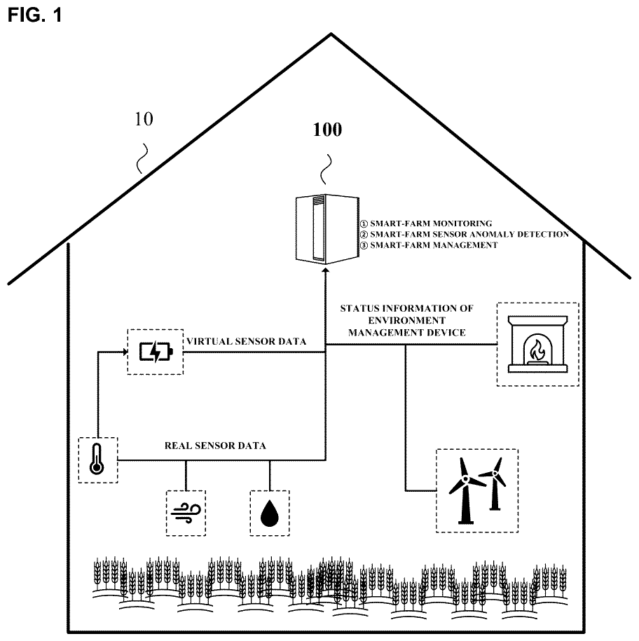

FIG. 1 is a view illustrating the overall process in which a management apparatus 100 manages a SmartFarm 10.

The management apparatus may receive real sensor data. The management apparatus may receive virtual sensor data. The management apparatus may receive status data of an environment management device. The management apparatus may monitor the SmartFarm on the basis of the received data. The management apparatus may analyze the monitoring result with a deep learning model, and may detect whether there is an abnormality in a real sensor and a virtual sensor. The management apparatus may manage the SmartFarm by controlling the real sensor, the virtual sensor, and the environment management device on the basis of the detection result.

The real sensor may include a temperature sensor and a humidity sensor.

The real sensor may be a sensor that actually performs a measurement. The real sensor may affect the data of the virtual sensor.

The real sensor data may include information about an environment inside a livestock barn. For example, the real sensor data may include information such as a temperature, a humidity, and so on inside the livestock barn.

The virtual sensor may include a sensor measuring a new value by processing a measurement value of the real sensor. The virtual sensor may receive data input from the surrounding real sensors.

The virtual sensor data may be data acquired by processing a value measured from the real sensor inside the livestock barn. For example, the virtual sensor data may be data that represents the air quality inside the livestock barn considering the temperature and a wind direction inside the livestock barn.

The environment management device may be a model for managing the environment inside the livestock barn. For example, the environment management device may include a heater, a ventilation fan, a hot air blower, and so on.

The status data of the environment management device may include information about the current status of the environment management device. For example, the status data of the environment management device may include information on whether the environment management device is powered on, information on what temperature the heater is currently set to manage, information on how much ventilation the ventilation fan is currently providing, and so on.

The real sensor data, the virtual sensor data, and the status data of the environment management device may be interrelated. For example, when the heater inside the livestock barn is operated, the temperature inside the livestock barn may be changed. As another example, when the ventilation fan inside the livestock barn is broken, the air quality inside the livestock barn may be changed.

The real sensor data, the virtual sensor data, and the status data of the environment management device may be stored in a database.

The database may store the real sensor data, the virtual sensor data, and the status data of the environment management device measured for several days.

In the database may store data from a few days before a sensor malfunction. Alternatively, the database may store data from a few days before each sensor is normally operated. The deep learning model may be a model for predicting a sensor failure by receiving the data when the sensor malfunction occurs and the data when each sensor is normally operated.

The management apparatus may monitor the SmartFarm by using the real sensor data, the virtual sensor data, and the environment management device data.

The SmartFarm management apparatus may detect an abnormality of each sensor by using the deep learning model. The deep learning model may be an anomaly detection model.

The deep learning model may be a Long Short Term Memory (LSTM)-based model. That is, when the real sensor data, the virtual sensor data, and the status data of the environment management device are time-series data, the deep learning model may process the data by considering a temporal relationship.

The deep learning model may be a transformer-based model. That is, in the deep learning model, an output value may be determined by considering the mutual relationship between the real sensor data, the virtual sensor data, and the environment management device data.

The management apparatus may manage the SmartFarm. The management apparatus may control the real sensor, the virtual sensor, and the environment management device.

The management apparatus may use
a reinforcement learning model.

The reinforcement learning model may output control information controlling the real sensor, the virtual sensor, or the environment management device by using the real sensor data, the virtual sensor data, and the status data of the environment management device.

For example, when one of the three real sensors in the livestock barn is broken, the control information may be output so that a sensor range of one real sensor of the remaining real sensors is expanded.

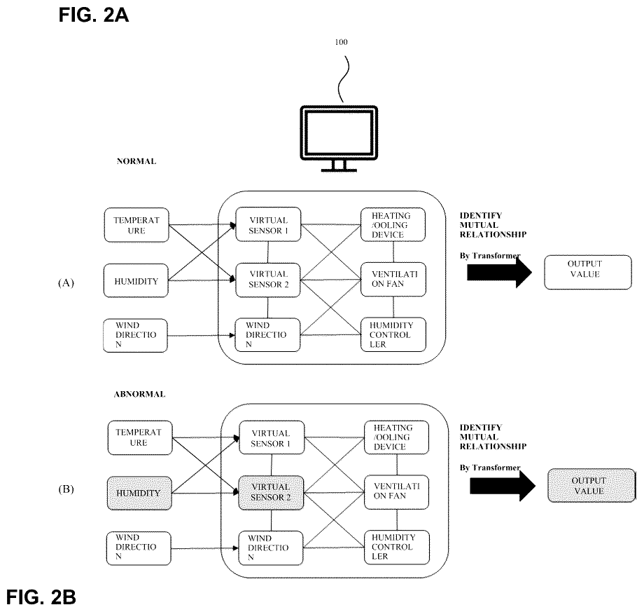

FIG. 2 shows an embodiment in which the management apparatus according to some embodiments detects an abnormality.

The management apparatus may receive information about a temperature, a humidity, and a wind direction. The information about the temperature, the humidity, and the wind direction may be information measured from the real sensor.

The management apparatus may be provided with two virtual sensors. Each virtual sensor may receive the information about the temperature or the information about the humidity.

The management apparatus may receive information about the status of the environment management device. The environment management device may include a heating/cooling device, the ventilation fan, and a humidity controller.

The management apparatus may identify the relationship between the receive information. The management apparatus may identify the mutual relationship by using the deep learning model. The deep learning model may be the transformer-based model.

FIG. 2(A) shows a case in which each sensor is normal.

FIG. 2(B) shows a case in which each sensor is abnormal.

FIG. 2(B) shows a case in which the humidity sensor is broken. In FIG. 2(B), since the humidity sensor is broken, information about the humidity may be inaccurate. Therefore, a problem may occur in the virtual sensor 2 that mainly uses humidity information.

The management apparatus may compare an output value when each sensor is normal with an output value when each sensor is abnormal. Through this, the management apparatus may determine whether there is an abnormality in each sensor. Alternatively, the management apparatus may determine whether there is an abnormality in each sensor on the basis of the output value.

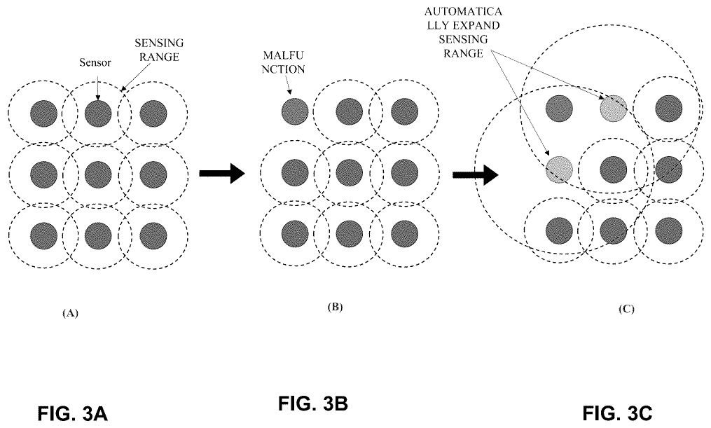

FIG. 3 shows an embodiment in which the management apparatus controls each sensor.

FIG. 3 shows an example in which nine sensors are disposed inside the livestock barn. Each sensor may have the same or different sensing ranges.

FIG. 3(A) shows a normal state of each sensor.

FIG. 3(B) shows a state in which one of the nine sensors is broken. Since the sensor is broken, a region detected by the sensor that is broken cannot be sensed. The management apparatus may use the anomaly detection model described above, thereby detecting that one of nine sensors is broken.

FIG. 3(C) shows that the management apparatus controls each sensor. In the drawings, the management apparatus controls sensors located near the broken sensor. Accordingly, the sensing range of the sensors near the broken sensor has been expanded.

Hereinafter, a configuration of a management apparatus 400 will be described.

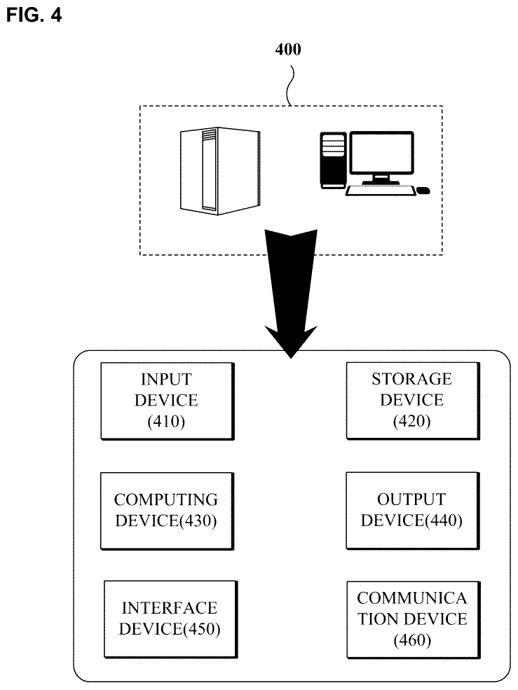

FIG. 4 is a view illustrating a configuration of a SmartFarm management apparatus. The management apparatus in FIG. 4 may be the same as the abnormality management apparatus 100 in FIG. 1.

The management apparatus 400 may be implemented in various physical forms, such as a PC, a laptop, a smart device, a chipset dedicated to a server or data processing, and so on. The management apparatus 400 may include an input device 410, a storage device 420, a computing device 430, an output device 440, an interface device 450, and a communication device 460.

The input device 410 may include an interface device (a keyboard, a mouse, a touch screen, and so on) that receives a specific command or data. The input device 410 may include a configuration in which information is inputted through a separate storage device (a USB, a CD, a hard disk, and so on). The input device 410 may receive input data through a separate measurement device or may receive input data through a separate DB. The input device 410 may receive data through wired or wireless communication.

The input device 410 may receive the real sensor data, the virtual sensor data, and the status data of the environment management device.

The storage device 420 may store information inputted through the input device 410. The storage device 420 may store information that is generated when the computing device 430 performs a computing process. That is, the storage device 420 may include a memory. The storage device 420 may store a result calculated by the computing device 430. The storage device 420 may store the deep learning model. The storage device 420 may store a control model.

The computing device 430 may monitor the SmartFarm on the basis of the real sensor data, the virtual sensor data, and the status information of the environment management device. The computing device 430 may analyze the real sensor data, the virtual sensor data, and the status information of the environment management device by using the deep learning model, thereby being capable of detecting whether there is an abnormality in the real sensor and the virtual sensor. The computing device 430 may manage the SmartFarm on the basis of the detection result. The computing device 430 may manage the SmartFarm by using the reinforcement learning model. The computing device 430 may monitor the SmartFarm by using the transformer-based model.

The output device 440 may be a device that outputs specific information. The output device 440 may output an interface, input data, an analysis result, and so on required for the data process. The output device 440 may be implemented in various physical forms, such as a display, a device that outputs a document, and so on. The output device 440 may output a control signal controlling a controller.

The interface device 450 may be a device that receives a specific command and data from an outside. The interface device 450 may receive the real sensor data, the virtual sensor data, and the status data of the environment management device from an input device or an external storage device that is physically connected to the interface device 450. Alternatively, the interface device 450 may output a result analyzed by the management apparatus 400.

The communication device 460 refers to a configuration in which specific information is received and transmitted through a wired or wireless network. The communication device 460 may receive the real sensor data, the virtual sensor data, and the status data of the environment management device. The communication device 460 may receive data required to control the management apparatus 400.

The SmartFarm management method described above may be implemented as a program (or application) including a computer-executable algorithm.

The program may be stored and provided in a transitory or non-transitory computer-readable medium.

The non-transitory computer-readable medium is not a medium that stores data for a short time, such as a register, a cache, a memory, or the like, but a medium that stores data semi-permanently and is readable by a device. Specifically, the above various applications or programs may be stored and provided in a non-transitory computer-readable medium such as a CD, a DVD, a hard disk, a Blu-ray disc, a Universal Serial Bus (USB) memory, a memory card, a read-only memory (ROM), a programmable read-only memory (PROM), an erasable PROM (EPROM), an electrically EPROM (EEPROM), a flash memory, or the like.

The transitory computer-readable medium is one of various random-access memories (RAMs) such as a static RAM (SRAM), a dynamic RAM (DRAM), a synchronous DRAM (SDRAM), a double data rate (DDR) SDRAM, an enhanced SDRAM (ESDRAM), a SyncLink DRAM (SLDRAM), and a direct Rambus RAM (DRRAM).

The present exemplary embodiment and the accompanying drawings in this specification only clearly show a part of the technical idea included in the present disclosure, and it will be apparent that all modifications and specific exemplary embodiments that can be easily inferred by those skilled in the art within the scope of the technical spirit contained in the specification and drawings of the present disclosure are included in the scope of the present disclosure.

1. A SmartFarm management method comprising:
receiving, by a management apparatus, information measured by a real sensor, information measured by a virtual sensor, and status information of an environment management device;
monitoring, by the management apparatus, a SmartFarm on the basis of the information measured by the real sensor, the information measured by the virtual sensor, and the status information of the environment management device;
detecting, by the management apparatus, whether there is an abnormality in the real sensor and the virtual sensor by analyzing a monitoring result by using a deep learning model; and
managing, by the management apparatus, the SmartFarm by controlling the real sensor, the virtual sensor, and the environment management device on the basis of a detection result.

2. The SmartFarm management method of claim 1, wherein the deep learning model is a model detecting whether there is the abnormality in the real sensor and the virtual sensor on the basis of embedding information representing a mutual relationship between the information measured by the real sensor, the information measured by the virtual sensor, and the status information of the environment management device.

3. The SmartFarm management method of claim 1, wherein managing the SmartFarm comprises analyzing the detection result by using a reinforcement learning model and then controlling the real sensor, the virtual sensor, and the environment management device on the basis of an output value of the reinforcement learning model.
